(19) United States
(12) Patent Application Publication
(10) Pub. No.: US 2013/0010997 A1
(43) Pub. Date: Jan. 10, 2013

(54) AURICLE-INSTALLED APPARATUS

(75) Inventors: Akichika TANAKA, Chiba (JP); Takeshi ASAKAWA, Chiba (JP); Naoya SAZUKA, Tokyo (JP); Toshimitsu TSUBOI, Tokyo (JP); Seiji WADA, Kanagawa (JP)

(73) Assignee: SONY CORPORATION, Tokyo (JP)

(21) Appl. No.: 13/533,240

(22) Filed: Jun. 26, 2012

(30) Foreign Application Priority Data
Jul. 4, 2011 (JP) 2011-147979

(51) Int. Cl. H04R 1/10

(52) U.S. Cl. 381/380

(57) ABSTRACT

An auricle-installed apparatus, including: a device configured to be installable to a user's ear and have an electric conversion function; and a main body including a supporting portion configured to support the device, and a first curved portion and a second curved portion that are configured to be installable to a user's auricle, the first curved portion and the second curved portion having a first state configured to maintain a first curved shape and a second state configured to maintain a second curved shape different from the first curved shape.

### BACKGROUND

The present technology relates to an auricle-installed apparatus including a non-contact temperature sensor and the like.

From the past, as a method of monitoring biological rhythm, a method of obtaining and monitoring a biological signal from an ear has been known. For example, Japanese Patent Application Laid-Open No. 2011-5176 describes an auricle-installed apparatus and a biological signal measuring apparatus for detecting brain waves from detection electrodes placed on a surface of an auricle opposite to bones surrounding the auricle.

However, in monitoring over long periods of time using the auricle-installed apparatus, the installed apparatus may fall off from the auricle due to a movement of a user's head. Moreover, when the installed apparatus is tried to be fixed to a circumference of the auricle using a resilient force such as a spring and rubber for preventing the fall-off, the user feels pain and discomfort in some cases due to applying pressure to the auricle by the installed apparatus.

In view of the circumstances as described above, it is desirable to provide the auricle-installed apparatus which is capable of preventing the fall-off from the auricle without applying pressure to the auricle.

### SUMMARY

According to an embodiment of the present technology, there is provided an auricle-installed apparatus including a device and a main body.

The device is configured to be installable to a user's ear and have an electric conversion function.

The main body includes a supporting portion configured to support the device, and a first curved portion and a second curved portion that are configured to be installable to a user's auricle, in which the first curved portion and the second curved portion include a first state configured to maintain a first curved shape and a second state configured to maintain a second curved shape different from the first curved shape.

The main body of the auricle-installed apparatus includes the first curved portion and the second curved portion configured to be installable to the user's auricle, which causes the first curved portion and the second curved portion to be each deformed in a different curved shape and can maintain the state. That is, since the main body can be deformed in shapes corresponding to two curved shapes of the user's auricle, it is possible to suppress the fall-off from the user's auricle even when external force is applied to the auricle-installed apparatus from various directions. Furthermore, since the first curved portion and the second curved portion of the main body can be maintained in the curved shapes, it is possible to install them without applying pressure to the user's ear.

The main body may further include a first end portion and a second end portion, and the first curved portion and the second curved portion may be formed between the first end portion and the second end portion.

Since the main body includes the end portions, it is easy to change the curved shapes of the first curved portion and the second curved portion and the distance between the first curved portion and the second curved portion, making it easier to correspond to users' various auricle sizes and shapes.

Furthermore, the supporting portion may be formed to the first end portion. Accordingly, for example, the first end portion to which the supporting portion supporting the device is formed can be placed in an external auditory meatus or on an earlobe, thereby enabling monitoring of a biological signal from the ear by the device.

The auricle-installed apparatus may further include a signal processing unit configured to process a signal one of inputted into and outputted from the device, and the signal processing unit may be connected to the main body.

Therefore, the biological signal and the like obtained by the device or an audio signal and the like inputted in the device can be processed within the auricle-installed apparatus, and the auricle-installed apparatus can be used as an apparatus such as a biological signal monitoring apparatus and a hearing aid, for example.

The auricle-installed apparatus may further include the first end portion and the second end portion, the first curved portion and the second curved portion may be formed between the first end portion and the second end portion, the supporting portion may be formed to the first end portion, and the signal processing unit may be connected to the second end portion.

The auricle-installed apparatus may further include a wiring that is placed in the main body to connect the device and the signal processing unit.

Since the wiring is placed in the main body, the main body can be more easily handled, and careless breaking and the like of the wiring can be prevented.

The main body may be formed annularly, the first curved portion is installable to an upper portion of the user's auricle, and the second curved portion may be installable to the user's earlobe.

That is, since even the annularly formed main body can be deformed corresponding to the curved shapes of the upper portion of the auricle and the earlobe of the user, it is possible to prevent the fall-off from the user's auricle when external force is applied to the auricle-installed apparatus from various directions.

The main body may maintain, in the first state, a distance between the first curved portion and the second curved portion that corresponds to a first distance, and, in the second state, the distance between the first curved portion and the second curved portion that corresponds to a second distance different from the first distance.

Therefore, even the annularly formed main body can change the distance between the first curved portion and the second curved portion corresponding to the user's auricle size.

The main body may further include a tab portion that is formed to the second curved portion and capable of maintaining a state protruded inwardly from the main body to be opposed to the user's earlobe.

That is, since the tab portion can be brought into contact with the user's earlobe while maintaining the inwardly protruded state, it is possible to further suppress the fall-off from the auricle-installed apparatus without providing a feeling of pressure to the user.

The device may be a photoelectric conversion element and also may be a non-contact temperature sensor, for example.

Accordingly, the auricle-installed apparatus can also be used as a non-contact thermometer, for example.

The device may be an electromechanical conversion element and also may be a speaker, for example. Therefore, the auricle-installed apparatus can also be used as an earphone, for example.

The auricle-installed apparatus may further include the signal processing unit that is connected to the main body to process an audio signal inputted in the speaker, and a microphone that is connected to the main body to output the audio signal to the signal processing unit.

Accordingly, the auricle-installed apparatus can also be used as a hearing aid or a wireless audio receiver, for example.

The main body may be formed of a plastically deformable shape-retaining material including one of metal and resin.

Therefore, it is easy to deform the first curved portion and the second curved portion into the first state configured to maintain the first curved shape and the second state configured to maintain the second curved shape different from the first curved portion.

As described above, according to the embodiments of the present technology, it is possible to provide the auricle-installed apparatus which is capable of preventing the fall-off from the auricle without applying pressure to the auricle.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a configuration of an auricle-installed apparatus according to a first embodiment of the present technology;

FIG. 2 is a diagram showing a configuration when the auricle-installed apparatus according to the first embodiment of the present technology is installed to a user's auricle;

FIG. 3A is a schematic view showing an internal configuration of a main body of the auricle-installed apparatus according to the first embodiment of the present technology; and FIG. 3B is a schematic view showing another example in the internal configuration of the main body of the auricle-installed apparatus according to the first embodiment of the present technology;

FIG. 4 is a diagram showing a circuit configuration as a non-contact thermometer of the auricle-installed apparatus according to the first embodiment of the present technology;

FIG. 5 is a diagram showing a configuration of the auricle-installed apparatus according to a second embodiment of the present technology;

FIG. 6 is a diagram showing, from the rear side of the user's auricle, a state in which the auricle-installed apparatus according to the second embodiment of the present technology is installed to the user's auricle;

FIG. 7 is a diagram showing a configuration of an auricle-installed apparatus according to a third embodiment of the present technology;

FIG. 8 is a diagram showing a configuration when the auricle-installed apparatus according to the third embodiment of the present technology is installed to the user's auricle;

FIG. 9 is a diagram showing a configuration of a modified example of the auricle-installed apparatus according to the third embodiment of the present technology;

FIG. 10 is a diagram showing a configuration of the modified example of the auricle-installed apparatus according to the third embodiment of the present technology;

FIG. 11 is a diagram showing a configuration of an auricle-installed apparatus according to a fourth embodiment of the present technology;

FIG. 12 is a diagram showing a configuration of an auricle-installed apparatus according to a fifth embodiment of the present technology;

FIG. 13 is a diagram showing a configuration of an auricle-installed apparatus according to a sixth embodiment of the present technology;

FIG. 14 is a diagram showing a circuit configuration as a hearing aid of the auricle-installed apparatus according to the sixth embodiment of the present technology;

FIG. 15 is a diagram showing a configuration of an auricle-installed apparatus according to a seventh embodiment of the present technology; and

FIG. 16 is a diagram showing a circuit configuration as a wireless audio receiver of the auricle-installed apparatus according to the seventh embodiment of the present technology.

### DETAILED DESCRIPTION OF EMBODIMENTS

Hereinafter, embodiments of the present technology will be described with reference to the drawings.

### First Embodiment

### (Configuration of Auricle-installed Apparatus)

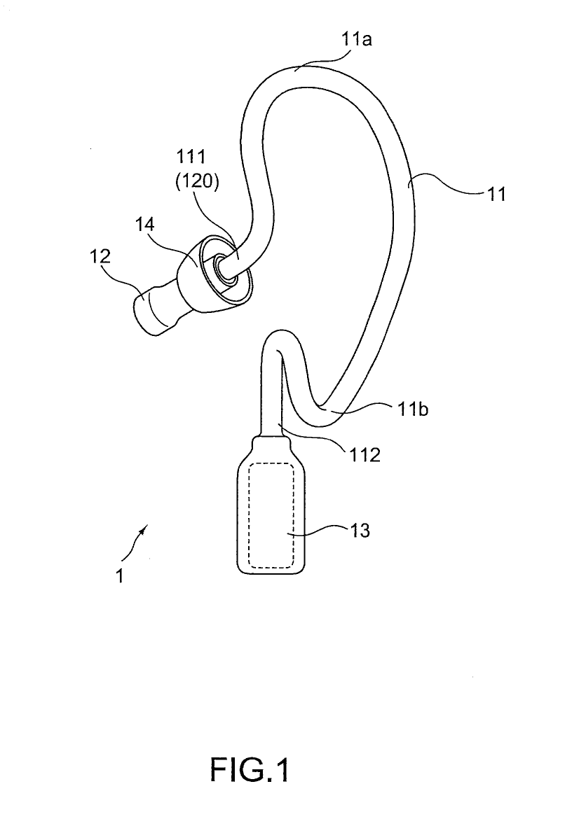

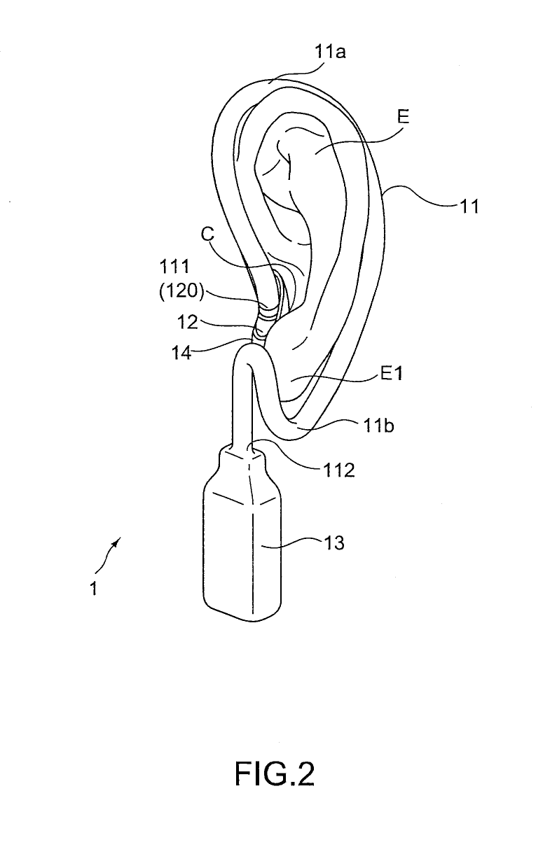

FIG. 1 is a diagram showing a configuration of an auricle-installed apparatus 1 according to an embodiment of the present technology and FIG. 2 is a diagram showing a state in which the auricle-installed apparatus 1 is installed to a user's left auricle E. In the present embodiment, the auricle-installed apparatus 1 is a non-contact thermometer for measuring a body temperature by detecting the user's eardrum temperature and includes a main body 11, a non-contact temperature sensor (device) 12, a signal processing unit 13, and an earpiece 14.

The main body 11 includes a first end portion 111, a second end portion 112, a first curved portion 11a, and a second curved portion 11b. A supporting portion 120 supporting the non-contact temperature sensor 12 is formed to the first end portion 111, and the second end portion 112 is connected to the signal processing unit 13. Moreover, the first curved portion 11a installable to the upper portion of the user's auricle E and the second curved portion 11b installable to an earlobe E1 positioned at a lower portion of the user's auricle E are formed between the first end portion 111 and the second end portion 112.

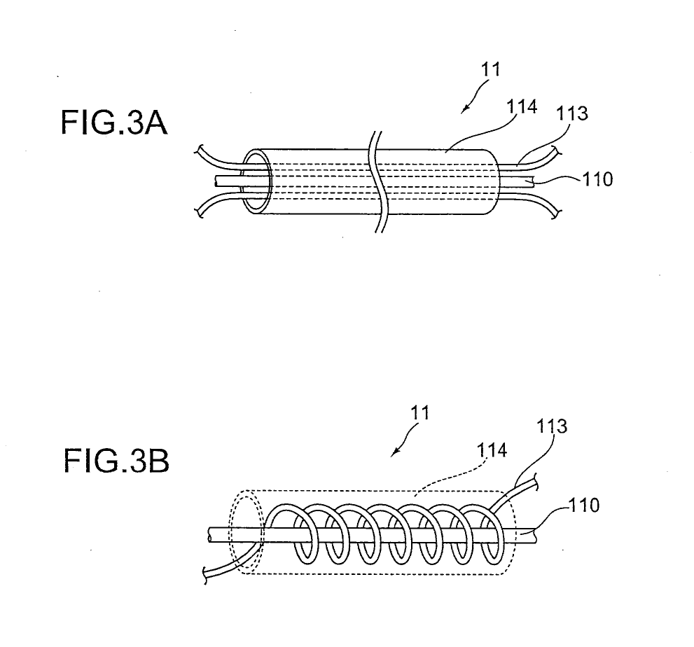

FIG. 3A is a schematic view showing a partial internal configuration of the main body 11. The main body 11 is formed of a plastically deformable shape-retaining material, and for example, is formed of a single wire 110 and a cover 114 including an elastic material such as a silicone resin. Moreover, a wiring 113 connecting the non-contact temperature sensor 12 and the signal processing unit 13 is disposed within the main body 11 and is coated together with the wire 110 with the cover 114. According to the embodiment, the main body 11 can be simply configured, so that the main body can be light about a weight of 4 grams, for example.

Moreover, FIG. 3B is a schematic view showing another example in a partial internal configuration of the main body 11 and shows an example in which the wiring 113 is wound around the wire 110, for example. Therefore, when the main body 11 is deformed, it is possible to prevent the wiring 113 from being broken. The wiring 113 may be entirely or partially wound around from the non-contact temperature sensor 12 to the signal processing unit 13.

The non-contact temperature sensor 12 is a pyroelectric infrared sensor in the embodiment. As shown in FIG. 2, the non-contact temperature sensor 12 is inserted into an external auditory meatus C of the user, detects infrared rays emitted from the eardrum, and outputs the detection result to the signal processing unit 13 as an electric signal via the wiring 113. Moreover, the earpiece 14 for supporting the non-contact temperature sensor 12 within the external auditory meatus C is disposed on the first end portion 111. The earpiece 14 is formed of a material such as a silicone resin, for example.

The signal processing unit 13 is connected to the second end portion 112 of the main body 11 and is disposed at a lower portion of the earlobe E1. The signal processing unit 13 is typically constituted of an electronic circuit substrate and the like and performs, for example, processing of converting the electric signal outputted from the non-contact temperature sensor 12 via the wiring 113 as measurements of the user's body temperature.

Since the auricle-installed apparatus 1 as configured above includes a single linear structure in which the main body 11 is formed of the plastically deformable shape-retaining material, the auricle-installed apparatus 1 can be deformed in a shape installable to the user's auricle E and further maintain the shape. Next, a method of installing the auricle-installed apparatus 1 to the user's auricle E will be described with reference to FIG. 1 and FIG. 2.

### (Installation Method of Auricle-installed Apparatus)

First, the main body 11 is deformed to facilitate installation to the user's auricle E. For example, the first curved portion 11a and the second curved portion 11b are curved gently and a distance between the first end portion 111 and the second end portion 112 can be expanded. Moreover, a distance between the first curved portion 11a and the second curved portion 11b can also be expanded equal to or more than a distance from the upper end of the auricle E to the lower end of the earlobe E1. In this case, the first curved portion 11a and the second curved portion 11b can maintain the deformed curved shape (first curved shape) (first state).

Next, the non-contact temperature sensor 12 is inserted into the external auditory meatus C, and the earpiece 14 is disposed in proximity of an opening of the external auditory meatus C. Then, the main body 11 is deformed in accordance with the user's auricle E to install the auricle-installed apparatus 1.

For example, the distance between the first curved portion 11a and the second curved portion 11b can be approximately narrowed to the distance from the upper end of the auricle E to the lower end of the earlobe E1. Furthermore, while the curved shape of the first curved portion 11a is shaped so as to hang over the upper portion of the auricle E, the curved shape of the second curved portion 11b can be deformed so that the user's auricle E is held lightly therebetween. In this case, the first curved portion 11a and the second curved portion 11b can maintain these curved shapes (second curved shape) (second state).

That is, the auricle-installed apparatus 1 can maintain the installation state without applying pressure to a circumference of the user's auricle E. Moreover, since the first curved portion 11a is hanged over the upper portion of the user's auricle E and then the second curved portion 11b holds the earlobe E1 therebetween for installation, it is possible to suppress the fall-off from the auricle E and stably measure the body temperature even when a direction of the external force applied to the auricle-installed apparatus 1 is not constant. Furthermore, since the auricle-installed apparatus 1 can be designed with lightweight, the burden on the user can be alleviated even for prolonged installation. Therefore, the auricle-installed apparatus 1 can be used to measure the body temperature under the condition where the external force can also be applied for a long time and from multiple directions in such a case where the body temperature is measured during activities or in sleeping, for example.

Next, a method of measuring the body temperature in the auricle-installed apparatus 1 will be described.

### (Method of Measuring Body Temperature in Auricle-installed Apparatus)

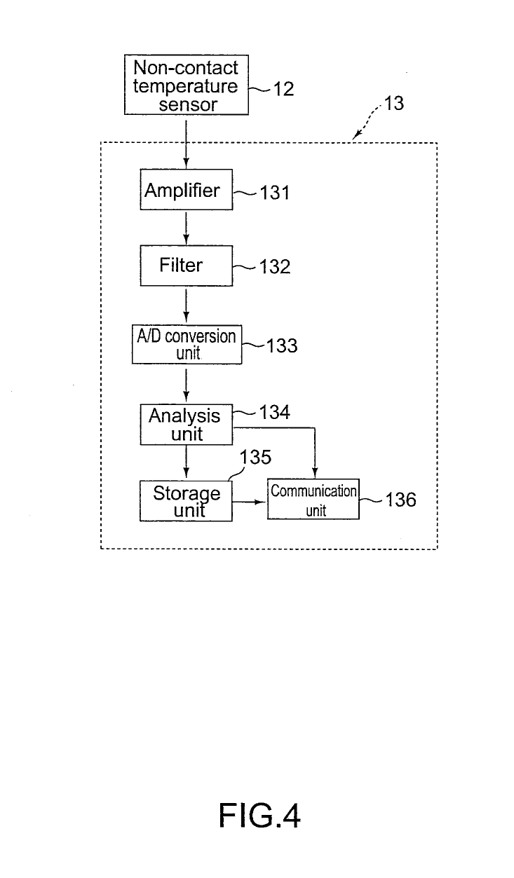

FIG. 4 is a diagram showing a circuit configuration as a non-contact thermometer of the auricle-installed apparatus 1. The signal processing unit 13 includes an amplifier 131, a filter 132, an A/D conversion unit 133, an analysis unit 134, a storage unit 135, and a communication unit 136.

First, the non-contact temperature sensor 12 detects an infrared ray emitted from the user's eardrum, converts the infrared ray into an electric signal, and outputs it to the amplifier 131 of the signal processing unit 13. The amplifier 131 amplifies the outputted electric signal. Furthermore, the filter 132 removes and corrects a predetermined band of noise.

Next, the A/D conversion unit 133 converts the electric signal from an analog signal to a digital signal and outputs it to the analysis unit 134. The analysis unit 134 is typically formed of an integrated circuit, analyzes the digital signal and determines a measurement temperature. The measurement temperature may be stored in the signal processing unit 13 by the storage unit 135 or may be transmitted to the communication unit 136.

The communication unit 136 outputs a signal of the obtained measurement temperature to an external device such as a computer (not shown). This output may be achieved through wireless communication or wired communication. In the case of achieving the output through the wireless communication, for example, the user can transmit the measurement result of the body temperature to the computer and the like while installing the auricle-installed apparatus 1. Moreover, in the case of achieving the output through the wired communication, for example, the measurement result is stored in the storage unit 135, the auricle-installed apparatus 1 removed from the auricle is connected to the computer and the like with a cable and the like after the completion of the measurement, and the measurement result stored in the storage unit 135 can be transmitted to the computer and the like.

With this method, the body temperature of the user's eardrum is measured by the auricle-installed apparatus 1. Moreover, since the auricle-installed apparatus 1 can maintain the installation state without applying pressure to the user's auricle E for prolonged installation, it is possible to measure the body temperature at specified intervals while installing the auricle-installed apparatus 1 for a long time and analyze circadian variations of the body temperature, for example.

It is noted that it is also possible to further provide the auricle-installed apparatus 1 with a display unit (not shown) connected to the communication unit 136 and display the obtained measurement temperature. Furthermore, the signal processing unit 13 may include a battery and the like for supplying electric power. When the display unit and the battery and the like are provided, a position for disposing them is not particularly limited. For example, both the battery and the display unit can be connected to the second end portion 112 together with the signal processing unit, and the display unit and the battery can be formed between the first curved portion 11a and the second curved portion 11b.

### Second Embodiment

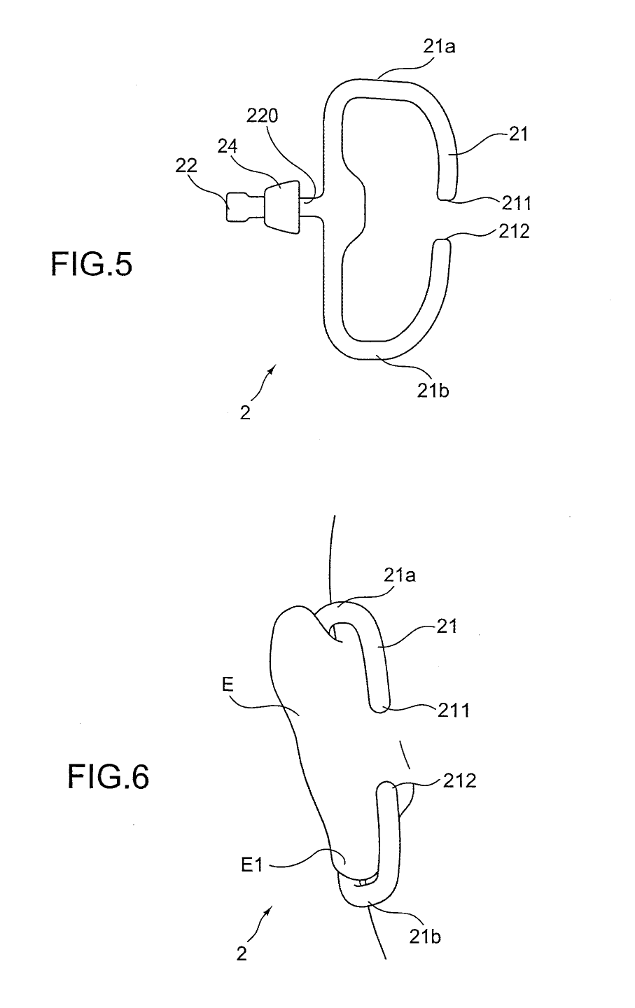

FIG. 5 is a diagram showing a configuration of an auricle-installed apparatus 2 according to a second embodiment of the present technology, and FIG. 6 is a diagram showing, from the rear side of the user's auricle E, a state in which the auricle-installed apparatus 2 is installed to the user's left auricle E. In the embodiment, the description of the configuration and function that are the same as those of the first embodiment will be omitted or simplified centering on the description of different portions from the first embodiment.

In the embodiment, the auricle-installed apparatus 2 is the non-contact thermometer for measuring the body temperature of the user's eardrum similar to the auricle-installed apparatus 1 of the first embodiment, and includes a main body 21, a non-contact temperature sensor (device) 22, and an earpiece 24. It is noted that the signal processing unit is not shown, but can be connected to a position of the main body 21 which is not obstacle to the user's installation.

The main body 21 is constituted of the plastically deformable shape-retaining material and includes a first end portion 211, a second end portion 212, a first curved portion 21a installable to the upper portion of the user's auricle E, and a second curved portion 21b installable to the earlobe E1. Furthermore, a supporting portion 220 supporting the non-contact temperature sensor 22 is formed between the first curved portion 21a and the second curved portion 21b.

In the embodiment, as shown in FIG. 6, the first end portion 211 and the second end portion 212 are both disposed at the rear side of the user's auricle E. Therefore, the distance between the first end portion 211 and the second end portion 212 can be adjusted in accordance with a shape of the user's auricle E, and for example, when the user's auricle E is small, the first end portion 211 and the second end portion 212 can be overlapped. This auricle-installed apparatus 2 allows the main body 21 to be easily deformed in accordance with the size and the shape of the user's auricle E.

Moreover, in addition to the above effect, the same function and effect as those of the auricle-installed apparatus 1 according to the first embodiment can also be obtained.

### Third Embodiment

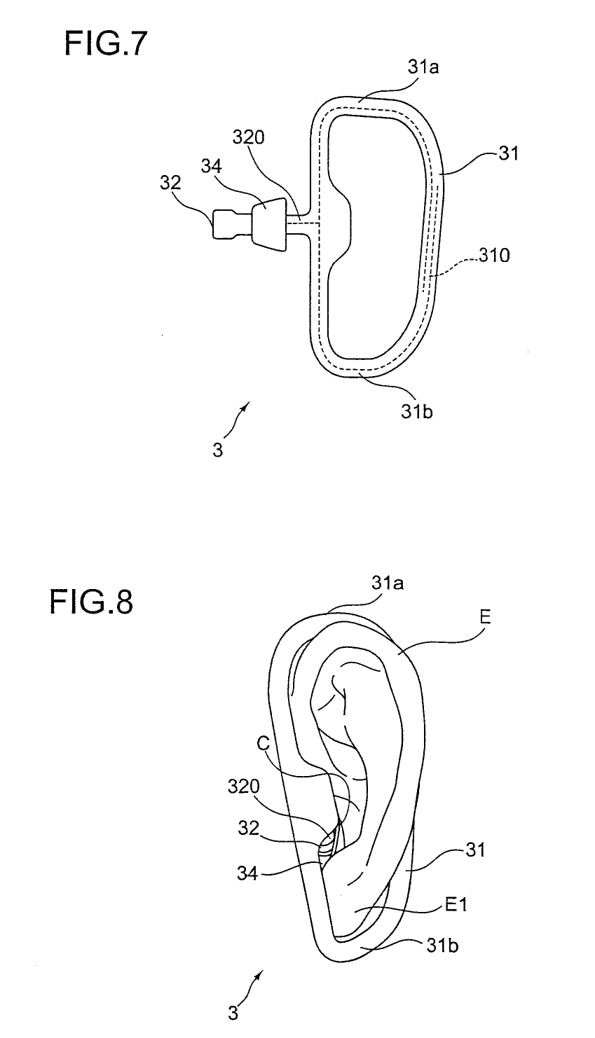

FIG. 7 is a schematic view showing a configuration of an auricle-installed apparatus 3 according to a third embodiment of the present technology, and FIG. 8 is a schematic view showing a state in which when the auricle-installed apparatus 3 is installed to the user's left auricle E. In the embodiment, the description of the configuration and function that are the same as those of the first embodiment will be omitted or simplified centering on the description of different portions from the first embodiment.

In the embodiment, the auricle-installed apparatus 3 is the non-contact thermometer for measuring the user's body temperature similar to the auricle-installed apparatus 1 of the first embodiment and includes a main body 31, a non-contact temperature sensor (device) 32, and an earpiece 34. It is noted that the signal processing unit is not shown, but can be connected to a position of the main body 31 which is not obstacle to the user's installation.

The main body 31 is constituted of the plastically deformable shape-retaining material and is annularly formed in the embodiment. The main body 31 includes a first curved portion 31a and a second curved portion 31b, and the first curved portion 31a is installable to the upper portion of the user's auricle E, and the second curved portion 31b is installable to the user's earlobe E1. Moreover, the main body 31 further includes a supporting portion 320 supporting the non-contact temperature sensor 32 between the first curved portion 31a and the second curved portion 31b.

The main body 31 is formed so that the curved shapes of the first curved portion 31a and the second curved portion 31b can be changed, the distance between the first curved portion 31a and the second curved portion 31b can also be changed, and then the main body 31 these shapes can be maintained. Moreover, the supporting portion 320 can be deformed and maintain the deformed shape, and for example, as shown in FIG. 8, the supporting portion 320 can be curved in accordance with the user's external auditory meatus C to install the non-contact temperature sensor 32 to the user's external auditory meatus C.

An example of a method of installing the auricle-installed apparatus 3 as described above to the user's auricle E will be described. First, while the distance between the first curved portion 31a and the second curved portion 31b is expanded to a first distance larger than the distance from the upper end of the auricle E to the lower end of the earlobe E1, the first curved portion 31a and the second curved portion 31b can be curved gently (first curved shape) and also this shape can be maintained (first state).

Then, the supporting portion 320 is curved downward in accordance with the user's external auditory meatus C, for example, as shown in FIG. 8, the non-contact temperature sensor 32 is inserted into the external auditory meatus C, and the distance between the first curved portion 31a and the second curved portion 31b can be approximately narrowed to a second distance from the upper end of the auricle E to the lower end of the earlobe E1. Furthermore, the curved shape of the first curved portion 31a is formed so as to hang over the upper portion of the auricle E, and the curved shape of the second curved portion 31b can be deformed so that the user's auricle E is held lightly therebetween. In this case, the first curved portion 11a and the second curved portion 11b can maintain these curved shapes (second curved shape) (second state).

A single wire 310 whose end portions are overlapped can be used as a material forming the main body 31 as indicated by the broken line in FIG. 7, for example. This makes it possible to adjust a length at which the end portions of the wire 310 are overlapped, change the distance between and the curved shapes of the first curved portion 31a and the second curved portion 31b, and maintain the shapes. Furthermore, by inserting the end portions of the wire 310 into a material such as rubber which can create friction with the wire 310, it becomes easier to maintain the distance between the first curved portion 31a and the second curved portion 31b.

It is noted that a constitutional material of the main body 31 is not limited to a material such as a plastically deformable wire, but the main body 31 may be constituted of a coil body, bellows-shaped resin and the like which can maintain the deformed shape. Moreover, a low melting point alloy having a softening temperature of 50° C. or lower (for example, U Alloy (product name) manufactured by Osaka Asahi Metal Mfg. Co., Ltd.) may be used. By using the low melting point alloy, it is possible to install the main body 31 by deforming the shape of the main body 31 heated at the softening temperature and maintain the shape by cooling.

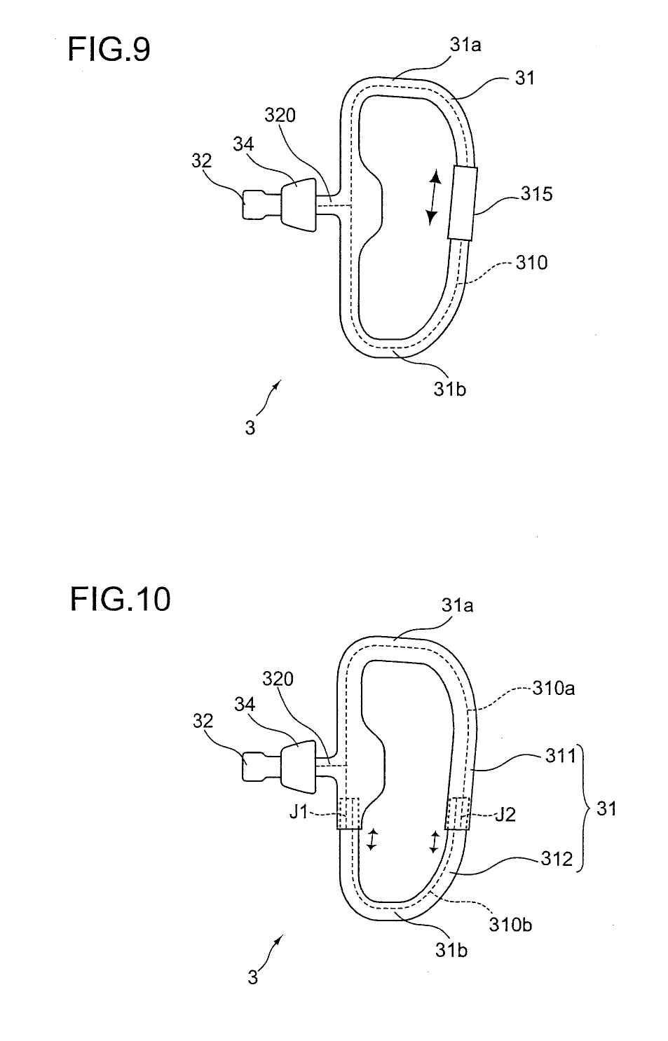

Furthermore, as shown in FIG. 9, the main body 31 further includes a deforming portion 315 which expands and contracts in the arrow directions and maintains the shape, only the deforming portion 315 can also be formed of the coil body and the bellows-shaped resin and the like to change the distance between the first curved portion 31a and the second curved portion 31b. In this case, the portions other than the deforming portion 315 can be formed of the plastically deformable wire 310 and the like.

Moreover, as shown in FIG. 10, the main body 31 may include a first main body 311 and a second main body 312. In this case, for example, the first main body 311 includes the first curved portion 31a and the supporting portion 320, and the second main body 312 includes the second curved portion 31b. The first main body 311 and the second main body 312 are mutually fitted via a first connection point J1 and a second connection point J2, thereby forming the main body 31 annularly. Moreover, the first main body 311 and the second main body 312 can also include a wire 310a and a wire 310b therein, respectively.

In the example shown in FIG. 10, it is possible to change the distance between the first curved portion 31a and the second curved portion 31b by adjusting a length by which the first main body 311 and the second main body 312 are fitted to each other in the arrow directions in FIG. 10 in the first connection point J1 and the second connection point J2. This makes it possible to change the distance between and the curved shapes of the first curved portion 31a and the second curved portion 31b and maintain the shapes.

The same function and effect as those of the auricle-installed apparatus 1 according to the first embodiment can also be obtained with the auricle-installed apparatus 3 as described above.

### Fourth Embodiment

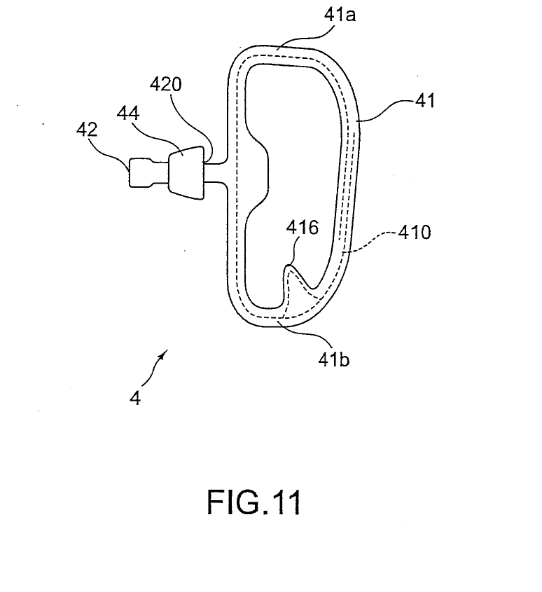

FIG. 11 is a diagram showing a configuration of an auricle-installed apparatus 4 according to a fourth embodiment of the present technology. As with the auricle-installed apparatus 3 according to the third embodiment, the auricle-installed apparatus 4 includes a main body 41 formed annularly, a non-contact temperature sensor (device) 42, an earpiece 44, and a signal processing unit (not shown). In the embodiment, the description of the configuration and function that are the same as those of the first embodiment and the third embodiment will be omitted or simplified centering on the description of different portions from the these embodiments.

The main body 41 is constituted of the plastically deformable shape-retaining material and includes a first curved portion 41a and a second curved portion 41b. Furthermore, in this embodiment, there is a difference from the auricle-installed apparatus 3 according to the third embodiment in that the main body 41 includes a tab (tab portion) 416.

The tab 416 is formed to the second curved portion 41b installed to the user's earlobe E1. Moreover, since the tab 416 is formed of a wire 410 similar to the main body 41, the tab 416 is capable of maintaining a state protruded inwardly from the main body 41 to be opposed to the earlobe when the user installs the auricle-installed apparatus 4. Therefore, for example, even when external force is applied to the auricle-installed apparatus 4, the tab 416 can support the earlobe and suppress the fall-off from the auricle of the main body 41.

Moreover, in addition to the above effect, the same function and effect as those of the auricle-installed apparatus 1 according to the first embodiment and the auricle-installed apparatus 3 according to the third embodiment can also be obtained.

### Fifth Embodiment

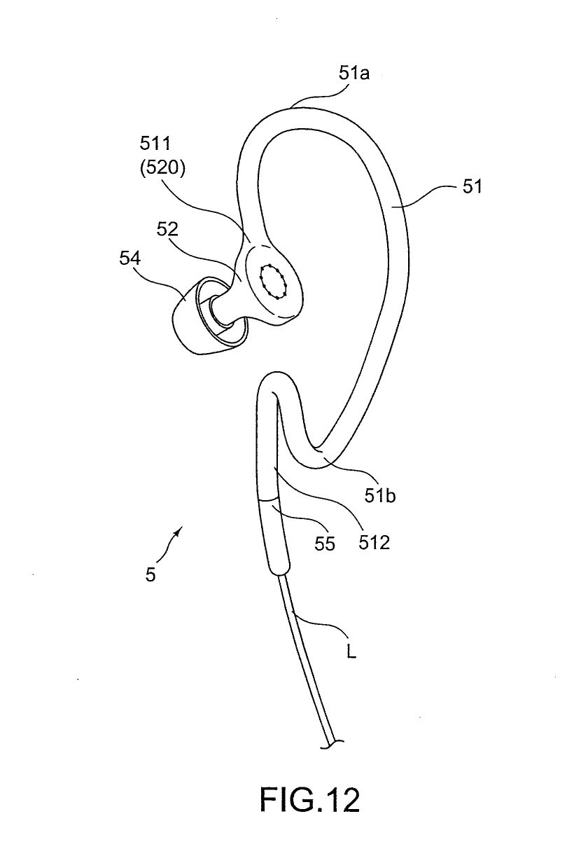

FIG. 12 is a diagram showing a configuration of an auricle-installed apparatus according to a fifth embodiment of the present technology. The auricle-installed apparatus according to the embodiment is an earphone 5 by which the user uses a portable music player and the like to listen to the music and the like and includes a main body 51, a speaker (device) 52, an earpiece 54, and an external connection terminal 55 having a cable L connected to an external device (not shown) such as a portable music player. In the embodiment, the description of the configuration and function that are the same as those of the first embodiment will be omitted or simplified centering on the description of different portions from the first embodiment.

The main body 51 is constituted of the plastically deformable shape-retaining material and includes a first end portion 511, a second end portion 512, a first curved portion 51a, and a second curved portion 51b. A supporting portion 520 supporting the speaker 52 is formed to the first end portion 511, and the external connection terminal 55 is connected to the second end portion 512. Moreover, the first curved portion 51a is installable to the upper portion of the user's auricle, and the second curved portion 51b is installable to the user's earlobe.

As with the first embodiment, the wire and the wiring (not shown) are disposed within the main body 51 and are coated with a cover. The wiring is connected to the speaker 52 and the external connection terminal 55, and an electric signal outputted to the external connection terminal 55 via the cable L from the external device (not shown) such as a portable music player is outputted to the speaker 52 via the wiring.

The speaker 52 is typically constituted of a ceramic type speaker and is an electromechanical conversion element for converting the outputted electric signal into an audio signal. It is noted that the speaker 52 is not limited to this structure.

The earphone 5 having the configuration as described above can obtain the same function and effect as those of the first embodiment. That is, the earphone 5 can maintain the installation state without applying pressure to a circumference of the user's auricle and then the fall-off from the auricle can be suppressed even when a direction of the external force applied to the earphone 5 is not constant. Accordingly, even while the user is performing exercises such as walking or running, the installation state can be stably maintained for a long time.

It is noted that the earphone 5 can be used as the portable music player by directly connecting the portable music player and the like to the main body 51 without the external connection terminal 55. Moreover, the earphone 5 may be provided with the signal processing unit connectable to the speaker 52, thereby allowing for wirelessly receiving the audio signal from the external device and outputting the signal to the speaker 52. This configuration can eliminate the necessity of the cable L and the like connecting the external connection terminal 55 and the external device and provide the earphone 5 which is more easily portable and allows for obtaining a stable installation feeling.

### Sixth Embodiment

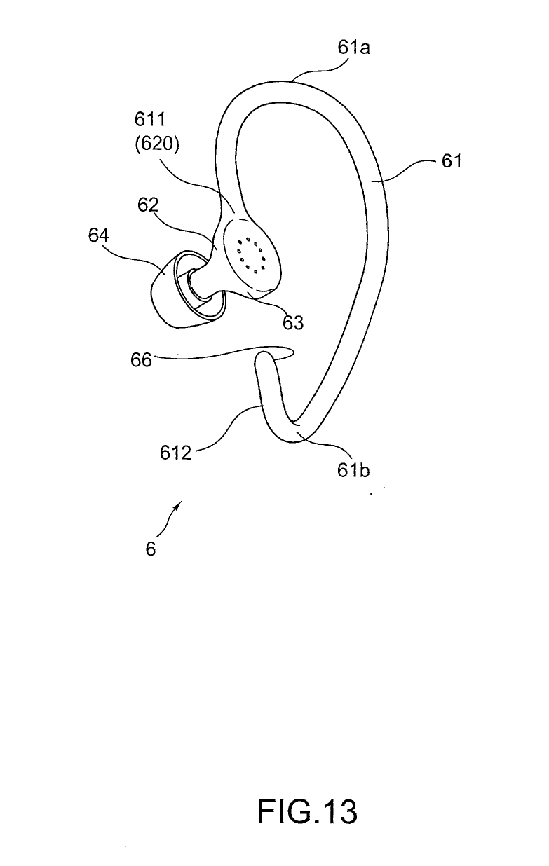

FIG. 13 is a diagram showing a configuration of an auricle-installed apparatus according to a sixth embodiment of the present technology. The auricle-installed apparatus according to the embodiment is a hearing aid 6 and includes a main body 61, a speaker (device) 62, a signal processing unit 63, an earpiece 64, and a microphone 66. In the embodiment, the description of the configuration and function that are the same as those of the first embodiment will be omitted or simplified centering on the description of different portions from the first embodiment.

The main body 61 is constituted of the plastically deformable shape-retaining material and includes a first end portion 611, a second end portion 612, a first curved portion 61a, and a second curved portion 61b. A supporting portion 620 supporting the speaker 62 is formed to the first end portion 611 to which the signal processing unit 63 is connected, and the microphone 66 is connected to the second end portion 612. Moreover, the first curved portion 61a is installable to the upper portion of the user's auricle, and the second curved portion 61b is installable to the user's earlobe.

The speaker 62 is typically constituted of a speaker such as a balanced armature type and is constituted as an electromechanical conversion element for converting the outputted electric signal into an audio signal. Moreover, the microphone 66 is typically constituted of a microphone such as a condenser microphone and is constituted as an electromechanical conversion element for converting the outputted audio signal into an electric signal. It is noted that the speaker 62 and the microphone 66 are not limited to these configurations.

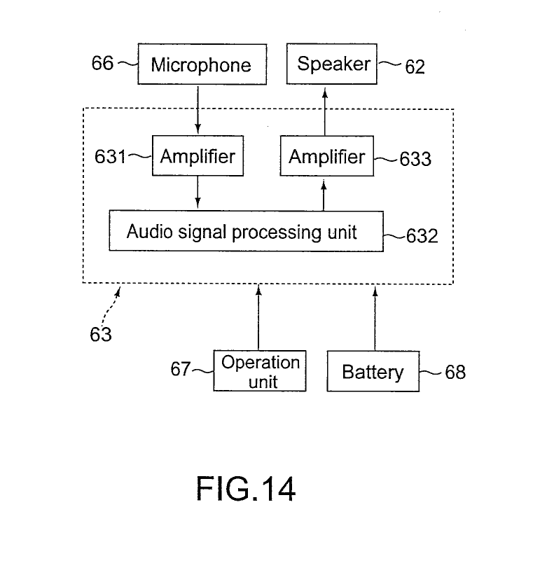

FIG. 14 is a diagram showing a circuit configuration of the hearing aid 6. The signal processing unit 63 includes an amplifier 631, an audio signal processing unit 632, and an amplifier 633. The electric signal outputted from the microphone 66 is first outputted to the amplifier 631 and is amplified. The amplified electric signal is outputted to the audio signal processing unit 632. The audio signal processing unit 632, for example, removes noise or amplifies a predetermined frequency band, and the resulting signal is then amplified by the amplifier 633. Subsequently, the electric signal is inputted from the amplifier 633 to the speaker 62 and is outputted from the speaker 62 as an audio signal.

Moreover, the hearing aid 6 may further include an operation unit 67 connected to the signal processing unit 63. For example, it is possible to perform a gain adjustment and an adjustment of a tone and the like of the amplifiers 631 and 633 in accordance with the user's hearing and the like by the operation unit 67. Furthermore, the hearing aid 6 may include a battery 68 for supplying electric power to the signal processing unit 63.

It is noted that the arrangement of the operation unit 67 and the battery 68 is not particularly limited so far as the operation unit 67 and the battery 68 can be connected to the signal processing unit 63.

The hearing aid 6 having the configuration as described above can obtain the same function and effect as those of the auricle-installed apparatus 1 according to the first embodiment. That is, the hearing aid 6 can maintain the installation state without applying pressure to the circumference of the user's auricle, and the fall-off from the auricle can be suppressed even when the direction of the external force applied to the hearing aid 6 is not constant.

### Seventh Embodiment

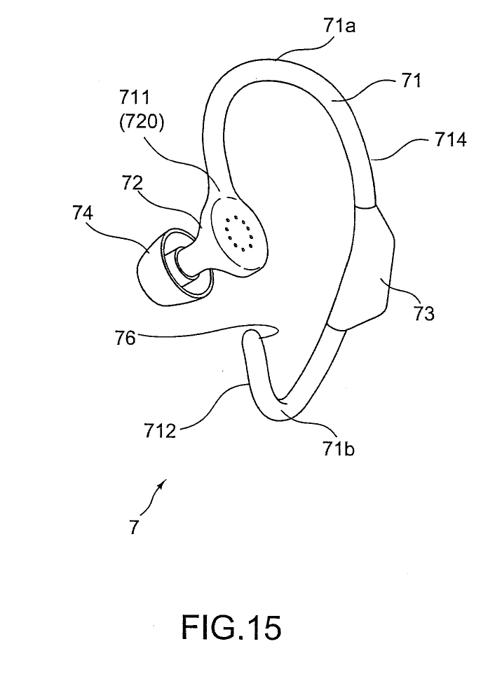

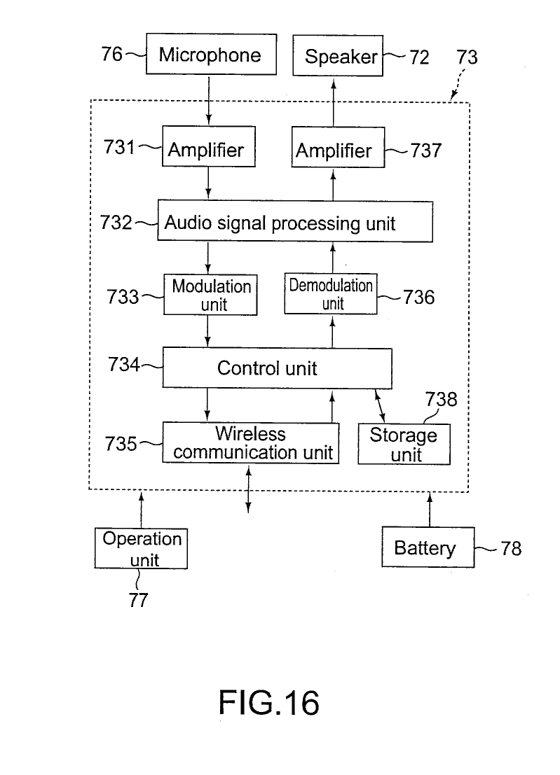

FIG. 15 is a diagram showing a configuration of an auricle-installed apparatus according to a seventh embodiment of the present technology. The auricle-installed apparatus according to the embodiment is a wireless audio receiver 7 and includes a main body 71, a speaker (device) 72, a signal processing unit 73, an earpiece 74, and a microphone 76. In the embodiment, the description of the configuration and function that are the same as those of the first embodiment will be omitted or simplified centering on the description of different portions from the first embodiment.

The main body 71 is constituted of the plastically deformable shape-retaining material and includes a first end portion 711, a second end portion 712, a first curved portion 71a, and a second curved portion 71b. A supporting portion 720 supporting the speaker 72 is formed to the first end portion 711, and the microphone 76 is connected to the second end portion 712. The signal processing unit 73 is formed between the first curved portion 71a and the second curved portion 71b. Moreover, the first curved portion 71a is installable to the upper portion of the user's auricle, and the second curved portion 71b is installable to the user's earlobe.

The speaker 72 is typically constituted of the ceramic type speaker and is the electromechanical conversion element for converting the outputted electric signal into an audio signal. Moreover, the microphone 76 is typically constituted of the microphone such as a condenser microphone and is the electromechanical conversion element for converting the outputted audio signal into an electric signal. It is noted that the speaker 72 and the microphone 76 are not limited to these configurations.

FIG. 12 is a diagram showing a circuit configuration of the wireless audio receiver 7. The signal processing unit 73 includes an amplifier 731, an audio signal processing unit 732, a modulation unit 733, a control unit 734, a wireless communication unit 735, a demodulation unit 736, an amplifier 737, and a storage unit 738. Moreover, the signal processing unit 73 is connected to an operation unit 77.

Transmission of audio to other wireless audio receivers and the like is performed in the following manner. First, the electric signal outputted from the microphone 76 is outputted to the audio signal processing unit 732 via the amplifier 731. The audio signal is outputted to the wireless communication unit 735 from the audio signal processing unit 732 via the modulation unit 733 and the control unit 734 and is transmitted to a predetermined receiver. On the other hand, the signal transmitted from the receiver is received via the wireless communication unit 735. The received signal is outputted to the speaker 72 via the control unit 734, the demodulation unit 736, the audio signal processing unit 732, and the amplifier 737. The control unit 734 controls the whole signal processing unit 73 for switching transmission and reception in accordance with the operation of the operation unit 77. The signal processing unit 73 includes the storage unit 738 storing transmission/reception signals (for example, signal relating to audio), but the storage unit 738 may be omitted if necessary.

Moreover, the wireless audio receiver 7 may include a battery 78 for supplying electric power to the signal processing unit 73. It is noted that the arrangement of the operation unit 77 and the battery 78 is not particularly limited so far as the operation unit 77 and the battery 78 can be connected to the signal processing unit 73.

The wireless audio receiver 7 having the configuration as described above can obtain the same function and effect as those of the first embodiment. That is, the wireless audio receiver 7 can maintain the installation state without applying pressure to the circumference of the user's auricle and the fall-off from the auricle can be suppressed even when the direction of the external force applied to the wireless audio receiver 7 is not constant.

### Modified Examples

Although the foregoing are descriptions on embodiments of the present technology, the present technology is not limited to these embodiments and that various changes and modifications may be made in the technology without departing from the spirit and scope thereof.

The above embodiments describe that the main body is constituted of the wire which is the plastically deformable shape-retaining material as the constitutional material. However, as shown in FIG. 10, the body may be formed of a plurality of wires. Moreover, a resin material such as a fiber-shaped plastically deformable polyethylene material can be used as other plastically deformable shape-retaining materials (see Japanese Patent No. 3582854), for example. This material has a blunt tip and provides a safety-enhancing feature in comparison with a metallic material, so that it can be expected that the user's installation feeling is further improved.

Moreover, the first curved portion and the second curved portion are not particularly limited so far as the first curved portion and the second curved portion are formed of materials which can maintain the shapes in the first state and the second state. For example, the low melting point alloy having a softening temperature of 50° C. or lower such as the coil body and the bellows-shaped resin described in the third embodiment may be used.

The main body can also be formed of a plurality of materials, and portions other than the first curved portion and the second curved portion of the main body can also be formed of a rigid body without the plastically deformable shape-retaining materials.

Moreover, the main body has been described as being provided with the cover coating the wire, the wiring and the like, but is not limited to this. The main body can be configured without using the cover. Alternatively, the main body can also be configured by using a plurality of covers.

The position at which the signal processing unit is formed is not particularly limited. Moreover, the signal processing unit may be omitted if necessary. In this case, for example, the signal inputted into or outputted from the device can also be received or transmitted by the signal processing unit disposed to the external device and the like through wireless communication. Moreover, the device and the signal processing unit have been described as being connected with the wiring, but are not limited to this configuration. For example, the device and the signal processing unit may transmit and receive the signal through wireless communication.

In the above embodiments, each of the auricle-installed apparatuses has been described as being provided with the earpiece, but the earpiece may be omitted if necessary.

In the above embodiments, the device is disposed toward the user's external auditory meatus, but is not limited to this configuration. For example, the supporting portion is formed to the second end portion disposable in proximity of the earlobe or the second curved portion and the like installed to the earlobe, and a photoelectric conversion element for detecting blood oxygen level and pulse waves and the like can also be disposed to the earlobe. For example, this photoelectric conversion element includes a light-emitting portion and a light-receiving portion disposed so as to hold the earlobe therebetween, the light-emitting portion causes red light to penetrate into the user's earlobe, and the light-receiving portion detects the penetrated light, thereby enabling detection of the blood oxygen level and the pulse waves from permeability of the penetrated light.

When the main body is formed annularly as described in the third embodiment and the fourth embodiment, a part of the main body can also be detachably formed. For example, when the main body includes the first main body which has the first curved portion and the second curved portion and the second main body which is detachable from the first main body and has the supporting portion, the supporting portion pre-curved in the shape of the right or left ear's external auditory meatus can be formed to the second main body. Then, when the main body is installed to an opposite ear, the second body is removed from the first body and the supporting portion can be re-installed in an orientation depending on an ear being an installation destination. The material for the second main body is not particularly limited and may be formed of a rigid body, for example. This auricle-installed apparatus can further improve the user's installation feeling without causing an uncomfortable feeling even in the case of the installation to the both ears.

Moreover, when the main body includes the first end portion and the second end portion, the main body includes a single linear structure which can deform and maintain the shape, so that the main body can also be used as the installed apparatus installed to a portion other than the user's auricle. For example, the installed apparatus can be used as a pulse measurement instrument installed to a wrist and can also be used as a brain wave measuring apparatus installed to a head if the main body is formed in a large size. These auricle-installed apparatuses can also obtain an effect that the fall-off can be suppressed without providing a feeling of pressure to the user even for prolonged installation.

Moreover, the present technology can be configured as follows.

(1) An auricle-installed apparatus includes: a device configured to be installable to a user's ear and have an electric conversion function; and a main body including a supporting portion configured to support the device, and a first curved portion and a second curved portion that are configured to be installable to a user's auricle, the first curved portion and the second curved portion having a first state configured to maintain a first curved shape and a second state configured to maintain a second curved shape different from the first curved shape.

(2) The auricle-installed apparatus according to Item (1), in which the main body further includes a first end portion and a second end portion, and the first curved portion and the second curved portion are formed between the first end portion and the second end portion.

(3) The auricle-installed apparatus according to Item (2), in which the supporting portion is formed to the first end portion.

(4) The auricle-installed apparatus according to Item (1), further including a signal processing unit configured to process a signal one of inputted into and outputted from the device, in which the signal processing unit is connected to the main body.

(5) The auricle-installed apparatus according to Item (4), in which the main body further includes a first end portion and a second end portion, the first curved portion and the second curved portion are formed between the first end portion and the second end portion, the supporting portion is formed to the first end portion, and the signal processing unit is connected to the second end portion.

(6) The auricle-installed apparatus according to Item (4) or (5), further including a wiring that is placed in the main body to connect the device and the signal processing unit.

(7) The auricle-installed apparatus according to Item (1) or (4), in which the main body is formed annularly, the first curved portion is installable to an upper portion of the user's auricle, and the second curved portion is installable to a user's earlobe.

(8) The auricle-installed apparatus according to Item (7), in which the main body maintains, in the first state, a distance between the first curved portion and the second curved portion that corresponds to a first distance, and, in the second state, the distance between the first curved portion and the second curved portion that corresponds to a second distance different from the first distance.

(9) The auricle-installed apparatus according to Item (7) or (8), in which the main body further includes a tab portion that is formed to the second curved portion and capable of maintaining a state protruded inwardly from the main body to be opposed to the user's earlobe.

(10) The auricle-installed apparatus according to any one of Items (1) to (9), in which the device is a photoelectric conversion element.

(11) The auricle-installed apparatus according to Item (10), in which the photoelectric conversion element is a non-contact temperature sensor.

(12) The auricle-installed apparatus according to any one of Items (1) to (9), in which the device is an electromechanical conversion element.

(13) The auricle-installed apparatus according to Item (12), in which the electromechanical conversion element is a speaker.

(14) The auricle-installed apparatus according to Item (13), further including: a signal processing unit that is connected to the main body to process an audio signal inputted in the speaker; and a microphone that is connected to the main body to output the audio signal to the signal processing unit.

(15) The auricle-installed apparatus according to any one of Items (1) to (14), in which the main body is formed of a plastically deformable shape-retaining material including one of metal and resin.

The present disclosure contains subject matter related to that disclosed in Japanese Priority Patent Application JP 2011-147979 filed in the Japan Patent Office on Jul. 4, 2011, the entire content of which is hereby incorporated by reference.

What is claimed is:

1. An auricle-installed apparatus, comprising:
a device configured to be installable to a user's ear and have an electric conversion function; and
a main body including
a supporting portion configured to support the device, and
a first curved portion and a second curved portion that are configured to be installable to a user's auricle, the first curved portion and the second curved portion having a first state configured to maintain a first curved shape and a second state configured to maintain a second curved shape different from the first curved shape.

2. The auricle-installed apparatus according to claim 1, wherein
the main body further includes a first end portion and a second end portion, and
the first curved portion and the second curved portion are formed between the first end portion and the second end portion.

3. The auricle-installed apparatus according to claim 2, wherein
the supporting portion is formed to the first end portion.

4. The auricle-installed apparatus according to claim 1, further comprising a signal processing unit configured to process a signal one of inputted into and outputted from the device, wherein
the signal processing unit is connected to the main body.

5. The auricle-installed apparatus according to claim 4, wherein
the main body further includes a first end portion and a second end portion,
the first curved portion and the second curved portion are formed between the first end portion and the second end portion,
the supporting portion is formed to the first end portion, and
the signal processing unit is connected to the second end portion.

6. The auricle-installed apparatus according to claim 4, further comprising a wiring that is placed in the main body to connect the device and the signal processing unit.

7. The auricle-installed apparatus according to claim 1, wherein
the main body is formed annularly,
the first curved portion is installable to an upper portion of the user's auricle, and
the second curved portion is installable to a user's earlobe.

8. The auricle-installed apparatus according to claim 7, wherein
the main body maintains, in the first state, a distance between the first curved portion and the second curved portion that corresponds to a first distance, and, in the second state, the distance between the first curved portion and the second curved portion that corresponds to a second distance different from the first distance.

9. The auricle-installed apparatus according to claim 7, wherein
the main body further includes a tab portion that is formed to the second curved portion and capable of maintaining a state protruded inwardly from the main body to be opposed to the user's earlobe.

10. The auricle-installed apparatus according to claim 1, wherein
the device is a photoelectric conversion element.

11. The auricle-installed apparatus according to claim 10, wherein
the photoelectric conversion element is a non-contact temperature sensor.

12. The auricle-installed apparatus according to claim 1, wherein
the device is an electromechanical conversion element.

13. The auricle-installed apparatus according to claim 12, wherein
the electromechanical conversion element is a speaker.

14. The auricle-installed apparatus according to claim 13, further comprising:
a signal processing unit that is connected to the main body to process an audio signal inputted in the speaker; and
a microphone that is connected to the main body to output the audio signal to the signal processing unit.

15. The auricle-installed apparatus according to claim 1, wherein
the main body is formed of a plastically deformable shape-retaining material including one of metal and resin.
